(19) United States
(12) Patent Application Publication
(10) Pub. No.: US 2026/0039629 A1
(43) Pub. Date: Feb. 5, 2026

(54) MEDIATOR AND AUTOMATION SYSTEM

(71) Applicant: Beckhoff Automation GmbH, Verl (DE)

(72) Inventors: Sebastian Böse, Rietberg (DE); Ralf Arnhold, Aschaffenburg (DE); Sebastian Petrovic, Bünde (DE); Daniel Schlotthauer, Berlin (DE); Benjamin Bruns, Celle (DE)

(21) Appl. No.: 19/352,941

(22) Filed: Oct. 8, 2025

Related U.S. Application Data
(63) Continuation of application No. PCT/EP2024/060287, filed on Apr. 16, 2024.

(30) Foreign Application Priority Data
Apr. 17, 2023 (DE) 10 2023 109 608.7

(51) Int. Cl. H04L 9/40; G05B 19/418

(52) U.S. Cl. CPC H04L 63/0245; G05B 19/4186

(57) ABSTRACT

A mediator comprises a mediator controller comprising an Industrial Ethernet protocol module, at least one Ethernet APL protocol module, and a translator module connected to the Industrial Ethernet protocol module and the at least one Ethernet APL protocol module. The Industrial Ethernet protocol module interprets Industrial Ethernet data provided via a first SPI interface and allocates Industrial Ethernet services. The at least one Ethernet APL protocol module interprets Ethernet APL data made available via a further SPI interface and allocates Ethernet APL services. The translator module connects the Industrial Ethernet services and the Ethernet APL services to one another and coordinates them in terms of time.

### CROSS-REFERENCE TO RELATED APPLICATIONS

This patent application is a continuation of International Patent Application No. PCT/EP2024/060287, filed Apr. 16, 2024, entitled “Mediator and Automation System,” which claims the priority of German patent application DE 10 2023 109 608.7, filed Apr. 17, 2023, entitled “Vermittler und Automatisierungssystem,” each of which is incorporated by reference herein, in the entirety and for all purposes.

### FIELD

The invention relates to a mediator and an automation system comprising such a mediator.

### BACKGROUND

Modern concepts of industrial and process automation, i.e. the control and monitoring of technical processes with the help of software, are based on the idea of a central controller with a simultaneously distributed sensor/actuator level. A network, also referred to as a field bus system, connects the field devices such as sensors and actuators to the central controller.

In order to enable the network subscribers, i.e. the field devices and the central controller, to exchange messages via the fieldbus, a standardized protocol, hereinafter referred to as the fieldbus protocol, is used for message transmission between the subscribers, which defines who (identifier) outputs what (measured value, command) when (initiative) on the fieldbus.

The most widespread standard for a network protocol is Ethernet, which may be used to transmit message packets, also referred to as Ethernet telegrams, with user data up to a length of 1500 bytes at a transmission rate of up to the gigabit/s range.

The Ethernet protocol was first used in office communication networks. Due to the advantages of the Ethernet concept, which result from the use of standard hardware and software components as well as the possibility of achieving high transmission rates even with simple networking technology, the Ethernet protocol has now also become established in industrial and process automation.

Various fieldbus technologies are used in industrial and process automation, which differ in terms of the connecting structure, bus access and the Ethernet fieldbus protocol used. In many production systems, the requirement therefore arises to combine the fieldbus technologies used into a shared fieldbus solution.

In Ethernet-based fieldbus systems, the field devices are usually connected to the central controller via a mediator in the form of a switch, which comprises a number of connecting interfaces, also referred to as ports in the following. The switch may also be used to transmit various Ethernet fieldbus protocols simultaneously. The information as to which port an Ethernet telegram is to be forwarded to is decided by the switch based on the Ethernet address or the VLAN tag provided in the Ethernet fieldbus protocols. Broadcast or multicast addresses are also possible, in which the switch then forwards an Ethernet telegram to a plurality of ports.

In a switch, it may be disruptive if Ethernet communication is delayed due to cross-traffic, additional services, non-interruptible telegrams, switch architecture, etc. Furthermore, an Ethernet telegram that is to be forwarded by the switch must always be at least 64 bytes long, even if a field device only wants to transmit a few bytes of user data cyclically.

Analog interfaces or fieldbuses such as I/O-Link or HART (Highway Addressable Remote Transducer) are generally used to connect sensors and actuators directly to the automation system; however, these have a limited transmission rate compared to Ethernet. However, as digitalization and system monitoring progress, the amount of data from sensors and actuators in the automation system increases, which must be transmitted over long distances, especially in process automation.

With the Ethernet Advanced Physical Layer, also referred to as Ethernet-APL, the Ethernet standard IEEE 802.3 has been expanded to include a communication technology for long distances, in which an intrinsically safe two-wire Ethernet cable may be used, with the aid of which a simple 2-wire connection of field devices is possible.

In the OSI reference model, Ethernet-APL represents an extended physical layer (bit transfer layer) for single-pair Ethernet, which is based on 10BASE-T1L. Ethernet-APL may communicate over cable lengths of up to 1000 m at 10 Mbit/s, full duplex. Ethernet-APL supports superordinate Ethernet protocols such as EtherNet/IP, HART-IP, OPC-UA and PROFINET.

Fast Ethernet-based field bus systems, also referred to as Industrial Ethernet, generally use twisted pair cables with at least 4 wires as the physical layer for Ethernet telegram transmission for transmission rates of more than 10 Mbit/s. In order to be able to combine components for 10 Mbit/s with components for more than 10 Mbit/s, e.g. 100 Mbit/s or 1 Gbit/s, mediators are used that allow for protocol conversion between the different physical layers.

For the use of Ethernet-APL, the field devices used must fulfill additional properties and functions. In addition to appropriate physical connectivity through plug-in or terminal connectors and properties for compliance with explosion protection, the field devices used also require supplementary or adapted software. In principle, it is therefore desirable to be able to combine Ethernet APL-capable field devices with conventional field devices.

A mediator and an automation system is provided with the aid of which Ethernet APL field devices may be easily integrated into an Industrial Ethernet field bus system.

### SUMMARY

According to an aspect, a mediator comprises a mediator controller, the mediator controller comprising an Industrial Ethernet protocol module, at least one Ethernet APL protocol module and a translator module connected to the Industrial Ethernet protocol module and the at least one Ethernet APL protocol module. The Industrial Ethernet protocol module is configured to interpret Industrial Ethernet data provided via a first SPI interface and to allocate Industrial Ethernet services. The at least one Ethernet APL protocol module is configured to Ethernet APL data made available via a further SPI interface and to allocate Ethernet APL services. The translator module is configured to connect the Industrial Ethernet services and the Ethernet APL services to one another and to coordinate them in terms of time.

According to another aspect, a mediator comprises a first connecting interface for a first Ethernet media type, which is an industrial Ethernet having a transmission rate of more than 10 Mbit/s, a first switch-on unit connected to the first connecting interface for the first Ethernet media type, at least one second connecting interface for a second Ethernet media type, which is an Ethernet APL 10 Base-T1L having a transmission rate of 10 Mbit/s on a single-pair Ethernet cable, at least one second switch-on unit for the second Ethernet media type connected to the at least one second connecting interface, a mediator controller which comprises an industrial Ethernet protocol module, at least one Ethernet APL protocol module and a translator module connected to the industrial Ethernet protocol module and the at least one Ethernet APL protocol module, a first SPI (Serial Peripheral Interface) interface, which connects the first switch-on unit to the industrial Ethernet protocol module of the mediator controller, a further SPI interface, which connects the second switch-on unit to the at least one Ethernet APL protocol module of the mediator controller.

The first switch-on unit processes Industrial Ethernet data from Industrial Ethernet telegrams transmitted by the first connecting interface and exchanging them with the Industrial Ethernet protocol module of the mediator controller via the first SPI interface. The Industrial Ethernet protocol module interprets the Industrial Ethernet data made available via the first SPI interface and allocates Industrial Ethernet services. The at least one second switch-on unit processes Ethernet APL data from Ethernet APL telegrams transmitted by the at least one second connecting interface and exchanges them via the further SPI interface with the at least one Ethernet APL protocol module of the mediator controller The at least one Ethernet APL protocol module interprets Ethernet APL data made available via the further SPI interface and assigns Ethernet APL services. The translator module connects the Industrial Ethernet services and the Ethernet APL services to each other and coordinates them in time.

According to another aspect, an automation system comprises a server subscriber and a mediator as client subscriber. a mediator comprises a mediator controller, the mediator controller comprising an Industrial Ethernet protocol module, at least one Ethernet APL protocol module and a translator module connected to the Industrial Ethernet protocol module and the at least one Ethernet APL protocol module. The Industrial Ethernet protocol module is configured to interpret Industrial Ethernet data provided via a first SPI interface and to allocate Industrial Ethernet services. The at least one Ethernet APL protocol module is configured to Ethernet APL data made available via a further SPI interface and to allocate Ethernet APL services. The translator module is configured to connect the Industrial Ethernet services and the Ethernet APL services to one another and to coordinate them in terms of time.

### EXAMPLES

A mediator comprises a first connecting interface for a first Ethernet media type, which is an Industrial Ethernet having a transmission rate of more than 10 Mbit/s, and a first switch-on unit for the first Ethernet media type connected to the first connecting interface. Furthermore, the mediator comprises at least one second connecting interface for a second Ethernet media type, which is an Ethernet APL (10 Base-T1L) with a transmission rate of 10 Mbit/s on a single-pair Ethernet cable, and a second switch-on unit for the second Ethernet media type connected to the at least one second connecting interface.

The mediator further comprises a mediator controller that includes an industrial Ethernet protocol module, at least an Ethernet APL protocol module, and a translator module connected to the industrial Ethernet protocol module, and the at least one Ethernet APL protocol module, a first SPI (Serial Peripheral Interface) interface, which connects the first switch-on unit to the Industrial Ethernet protocol module of the mediator controller, and a further SPI interface, which connects the second switch-on unit to the at least one Ethernet APL protocol module of the mediator controller. The first switch-on unit processes Industrial Ethernet data from Industrial Ethernet telegrams transmitted by the first connecting interface and exchanges the Industrial Ethernet data with the Industrial Ethernet protocol module of the agent controller via the first SPI interface.

The Industrial Ethernet protocol module interprets the Industrial Ethernet data provided via the first SPI interface and assigns the Industrial Ethernet data to Industrial Ethernet services. The at least one second switch-on unit processes Ethernet APL data from Ethernet APL telegrams transmitted by the at least one second connecting interface and exchanges the Ethernet APL data with the at least one Ethernet APL protocol module of the mediator controller via the further SPI interface. The at least one Ethernet APL protocol module interprets the Ethernet APL data provided via the additional SPI interface and assigns the Ethernet APL data to Ethernet APL services. The translator module connects the Industrial Ethernet services and the Ethernet APL services with each other and coordinates the Industrial Ethernet services and the Ethernet APL services in terms of time.

The mediator allows for collectively transmitting the user data for Ethernet APL field devices connected to the mediator in an Ethernet telegram from a central controller. Neither a header or trailer nor a minimum telegram size of 64 bytes is required for each Ethernet APL field device. This saves telegram traffic and therefore also increases the performance of the automation system. In the mediator, the two Ethernet media types are completely separated from each other by the mediator controller. The control of the data exchange between the first connecting interface, also referred to below as the Industrial Ethernet port, and the second connecting interface, also referred to below as the Ethernet APL port, is controlled by the mediator controller, which achieves a high level of determinism. The embodiment of the mediator thus prevents interference from cross-traffic, especially if a plurality of Ethernet APL ports is provided.

The translator module in the mediator may comprise service filters that allow for simple mapping between the Industrial Ethernet services of the Industrial Ethernet protocol module and the Ethernet APL services of the Ethernet APL protocol module.

A firewall may be integrated in the translator module of the mediator controller in order to filter and/or to prevent unwanted communication. This may achieve improved security. All communication and services to the Ethernet APL field device run via the mediator controller and therefore via the firewall. There is no possibility of reaching the Ethernet APL field device via any other connection.

For Ethernet APL communication to the Ethernet APL field devices, a wide variety of superordinate Ethernet protocols such as EtherNet/IP, HART-IP, OPC-UA, PROFINET etc. may be used in the Ethernet APL protocol module of the mediator, which guarantees a high degree of flexibility.

An EtherCAT switch-on unit may be installed as the first switch-on unit in the mediator, which processes the EtherCAT data from the Ethernet telegrams passing through on the internal Ethernet terminal bus and makes it available to the mediator controller via the first SPI interface. The EtherCAT protocol is then used in the Industrial Ethernet protocol module. The switching unit thus forms an EtherCAT working node and also provides one or more Ethernet APL ports for the field level, to each of which one or more sensors or one or more actuators may be connected.

The embodiment of the mediator as a terminal block allows for a high port density and a compact installation space. By integrating the mediator into a terminal block housing, a modular and flexible integration of the Ethernet APL is achieved.

The multi-port terminal block offers the option of using terminal connections to connect Ethernet APL-capable field devices to an automation system that uses an industrial Ethernet with transmission rates of more than 10 Mbit/s and uses twisted pair cables with at least 4 cores or rigid connections with at least 4 conductors for Ethernet telegram transmission as the physical layer.

Any number of terminal blocks may be operated with a terminal block string that includes the mediator as a terminal block, so that signals from field devices may also be recorded with other physical layers such as IO-Link or HART in addition to Ethernet-APL as the physical layer. A combination with other terminal types is possible, which ensures simple integration into existing systems and modular expandability.

In the automation system, the user data may be transmitted collectively from a server subscriber as the central controller to the agent as the client subscriber. This means that no header information and therefore no minimum Ethernet telegram size of 64 bytes is required for the individual field device in the Ethernet telegram. This saves data traffic and increases performance.

A bus terminal unit may be provided in the automation system, which has a bus coupler and a number of terminal blocks, wherein the mediator is a terminal block. In the Bus Terminal unit, Bus Terminals with a wide variety of signal types, including Ethernet APL, may be connected in any desired sequence with the repeater. It is also possible to replace individual Bus Terminals or expand the Bus Terminal unit at a later date.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an automation system having a mediator.

FIG. 2 shows the schematic structure of the mediator in the automation system from FIG. 1.

FIG. 3 shows the schematic structure of the mediator controller of the switching unit from FIG. 2.

FIG. 4 shows a terminal block arrangement for use in the automation system shown in FIG. 1.

### DETAILED DESCRIPTION

The figures are merely schematic in nature and not to scale. Furthermore, the reference numerals in the figures have been chosen unchanged if the elements or components are of the same embodiment.

In industrial and process automation, networks are used to connect distributed field devices at sensor/actuator level to a central controller. The automation networks usually comprise a serial bus, also referred to as a field bus, to which the network subscribers are connected.

In automation networks, manufacturers use various fieldbus concepts that differ in terms of the connection structure, bus access and the standardized fieldbus protocol.

The fieldbus protocol defines how data are to be exchanged between the subscribers on the fieldbus. The fieldbus protocol determines the rules and formats for the communication behavior of the subscribers. The fieldbus protocol generally has a layered architecture, wherein the individual protocol layers are defined in the OSI reference model.

The message structure defined by the fieldbus protocol contains all the important information for data exchange, such as sender and recipient, message type, message size and checksum to ensure error-free transmission. This information is pre-attached to the user data in the message as a header or attached as a trailer.

The Ethernet protocol has established itself as the communication standard for fieldbus systems. As part of the OSI layer model, the Ethernet protocol defines the two lowest protocol layers, the bit transmission layer, also referred to as the physical layer, and the data link layer. For data transmission in the higher protocol layers, standard communication protocols such as the TCP/IP protocol may be used in the Ethernet concept.

The Ethernet protocol divides up the data to be transmitted into frames, also referred to as telegrams, the structure of which is defined in the IEEE 802.3 standard. The Ethernet telegram is preceded by a preamble and a start bit, referred to as Start Frame Delimiter SFD. This is followed by the actual Ethernet telegram. The Ethernet telegram consists of a header section, the header, a user data block and an end section, the trailer.

The header starts with a 6-byte field for the destination address, which is followed by a further 6-byte field with the source address. This may be followed by a further 4-byte field, referred to as VLAN tag with additional control data in the header, which contains prioritization information in particular. The header ends with a 2-byte field, referred to as type field, which provides information about the protocol with which the data in the user data block is to be processed.

The user data block following the header may comprise a length of 1500 bytes, although larger data blocks are also permitted in various Ethernet protocol extensions. The user data block is terminated by a variable-length field, referred to as PAD field, which guarantees the defined minimum length of 64 bytes of the Ethernet telegram.

The user data block is followed by the trailer, which comprises a 4-byte field with a checksum. When an Ethernet telegram is created, a CRC calculation is carried out on the bit sequence and the checksum is appended to the data block. The receiver carries out the same calculation after receipt. If the checksum received does not match the self-calculated checksum, the receiver assumes that the transmission is faulty.

Real-time solutions based on the Ethernet protocol are also used in industrial and process automation. Real-time-capable fieldbus systems based on the Ethernet standard include PROFINET, EtherCAT, Powerlink and SERCOS III. The real-time-capable protocol used to process the data in the user data block is displayed in the type field in the header of the Ethernet telegram.

Fieldbus systems the message transmission of which is based on the Ethernet protocol are often operated in the form of server-client systems. The server subscriber in the fieldbus system is the central controller, which has bus access authorization and may output data to the fieldbus. The client subscribers in the field bus system are the field devices, such as I/O devices, drives, transmitters, etc. They do not have bus access authorization and may only acknowledge received data and transmit data upon request of the server subscriber.

In server-client systems, the server subscriber generally carries out cyclical control processes in order to generate output data for these and/or other client subscribers on the basis of input data from client subscribers.

After completion of a control process cycle, the server subscriber sends the output data in the form of Ethernet telegrams on the fieldbus, wherein the client subscribers take the output data assigned to the respective client subscriber from the Ethernet telegrams and execute a local subscriber process with this output data. The data determined by the local subscriber process is then in turn transferred from the client subscriber to the server subscriber and then used by the server subscriber as input data for the next control process cycle.

When using the real-time-capable EtherCAT protocol as part of a server-client system, the Ethernet telegrams are processed by the client devices in a continuous process. Each client device on the fieldbus is assigned its own data block area in the user data area of the Ethernet telegram.

Instead of a server-client configuration, a fieldbus system may also be operated with a provider-consumer model. In the provider-consumer model, each subscriber, i.e. both the central controller and the field devices on the fieldbus, offers data that may be requested by one or more of the other subscribers. The data is offered cyclically. The real-time-capable PROFINET protocol uses the provider-consumer model for Ethernet telegram exchange. The data in the user data area of the Ethernet telegram is then intended for the consumer subscriber named in the target address.

Fast Ethernet-based fieldbus systems, also referred to as Industrial Ethernet, allow for transmission rates of more than 10 Mbit/s using a twisted pair cable with at least 4 wires as the physical layer. In automation systems, Industrial Ethernet is therefore used for Ethernet devices such as drives, flow meters, analyzers and motor controllers as subscribers on the fieldbus, which are operated with at least 4 wires.

The Ethernet standard was developed with an Advanced Physical Layer, hereinafter referred to as Ethernet-APL, in order to allow for the use of the Ethernet standard for 2-wire devices such as sensors and actuators, which are conventionally connected in the automation system via analog interfaces or fieldbuses such as I/O-Link or HART (Highway Addressable Remote Transducer) with a limited transmission rate.

Ethernet-APL is an extended physical layer for single-pair Ethernet, which is implemented on 10 BASE-T1L in order to be able to communicate at 10 Mbit/s in full-duplex mode over cable lengths of up to 1000 m. As a physical layer, Ethernet-APL is able to support EtherNet/IP, HART-IP, OPC-UA, PROFINET or other superordinate Ethernet protocols.

The implementation of Ethernet-APL in field devices requires an adaptation of the device hardware with regard to the physical layer and the device software with regard to the protocol stack. It is therefore desirable to be able to continue to integrate non-extended field devices into the automation system alternatively via analog interface or fieldbuses such as I/O-Link or HART.

The two types of Ethernet media are completely separated from each other in the mediator by the mediator controller. The control of the data exchange between the first connecting interface, in the following also referred to as the industrial Ethernet port, and the second connecting interface, in the following also referred to as the Ethernet APL port, is controlled by the mediator controller, which achieves a high level of determinism. The embodiment of the mediator thus prevents interference from cross-traffic, especially if a plurality of Ethernet APL ports is provided.

In order to connect Industrial Ethernet field bus systems, in which the subscribers exchange Ethernet telegrams at transmission rates of more than 10 Mbit/s usually with a twisted pair cable with at least 4 wires for Ethernet telegram transmission as the physical layer, with Ethernet APL field devices that use a two-wire Ethernet cable with a transmission rate of 10 Mbit/s for communication, a mediator is used that enables conversion between the different physical layers.

For this purpose, the mediator comprises a first connecting interface for the Industrial Ethernet with a transmission rate of more than 10 Mbit/s, hereinafter also referred to as Industrial Ethernet port, and an Industrial Ethernet switch-on unit connected to the Industrial Ethernet port. Furthermore, the mediator comprises at least one second connecting interface for the Ethernet APL (10 Base-T1L) with a transmission rate of 10 Mbit/s on a single-pair Ethernet cable, hereinafter also referred to as Ethernet APL port, and an Ethernet APL switch-on unit connected to the Ethernet APL port.

The mediator further comprises a mediator controller comprising an Industrial Ethernet protocol module, at least one Ethernet APL protocol module and a translator module connected to the Industrial Ethernet protocol module and the at least one Ethernet APL protocol module, a first SPI (Serial Peripheral Interface) interface connecting the Industrial Ethernet switch-on unit to the Industrial Ethernet protocol module of the mediator controller, and a further SPI interface connecting the Ethernet APL switch-on unit to the at least one Ethernet APL protocol module, which connects the industrial Ethernet switch-on unit to the industrial Ethernet protocol module of the mediator controller, and a further SPI interface which connects the Ethernet APL switch-on unit to the at least one Ethernet APL protocol module of the mediator controller.

The Industrial Ethernet switch-on unit processes Industrial Ethernet data from Industrial Ethernet telegrams transmitted by the Industrial Ethernet port and exchanges the Industrial Ethernet data with the Industrial Ethernet protocol module of the mediator controller via the first SPI interface. The Industrial Ethernet protocol module interprets the Industrial Ethernet data made available via the first SPI interface and assigns the Industrial Ethernet data to Industrial Ethernet services.

The at least one Ethernet APL switch-on unit processes Ethernet APL data from Ethernet APL telegrams transmitted by the at least one Ethernet APL port and exchanges the Ethernet APL data with the at least one Ethernet APL protocol module of the mediator controller via the additional SPI interface. The at least one Ethernet APL protocol module interprets the Ethernet APL data provided via the additional SPI interface and assigns the Ethernet APL data to Ethernet APL services.

The translator module connects the Industrial Ethernet services and the Ethernet APL services with one another and coordinates the Industrial Ethernet services and the Ethernet APL services in terms of time.

The mediator allows for collectively transmitting the user data for the Ethernet APL field devices connected to the mediator in an Ethernet telegram by a server subscriber so that a header or trailer does not have to be provided for each Ethernet APL field device. The minimum telegram size of 64 bytes is not required for Ethernet telegrams, either. This saves telegram traffic and therefore also increases the performance of the automation system.

The two types of Ethernet media are completely separated from each other in the mediator by the intermediate mediator controller. The control of the data exchange between the Industrial Ethernet port and the Ethernet APL port is regulated by the mediator controller, which achieves a high level of determinism. The embodiment of the mediator thus prevents interference from cross-traffic, especially if a plurality of Ethernet APL ports is provided.

A firewall may be integrated into the translator module of the mediator controller in order to filter and/or to prevent unwanted communication. This improves security. All communication between the server subscriber and the Ethernet APL field devices takes place via the mediator controller and therefore via the firewall.

For Ethernet-APL communication to the Ethernet-APL field device, a wide variety of superordinate Ethernet protocols such as EtherNet/IP, HART-IP, OPC-UA, PROFINET etc. may be used in the Ethernet-APL protocol module of the mediator, which guarantees a high degree of flexibility.

In the following, the mediator is described for an automation system in which the real-time-capable EtherCAT protocol is used to interpret the data in the user data block of the Ethernet telegrams.

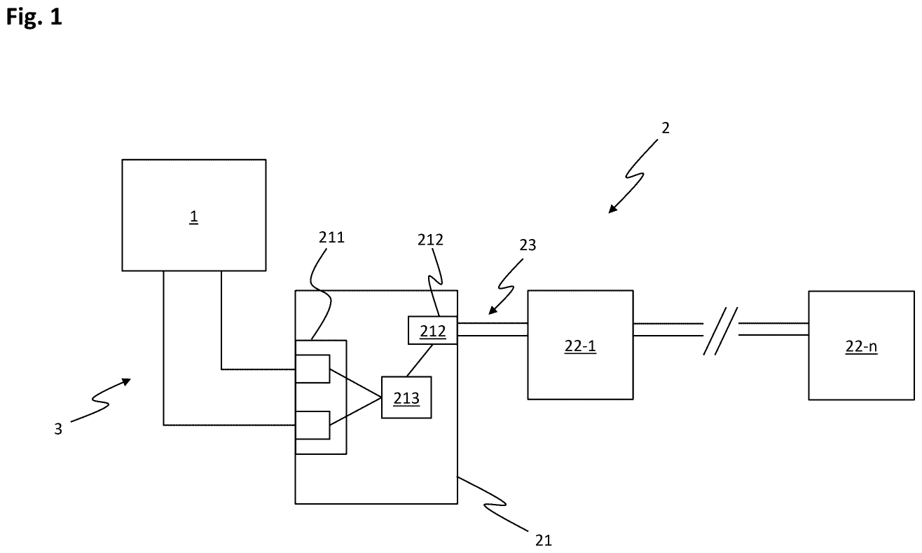

FIG. 1 schematically shows the basic structure of the automation system comprising a server subscriber 1, which forms the control level, and a client subscriber 2, which represents the sensor/actuator level, wherein the server subscriber 1 and the client subscriber 2 are connected via a serial fieldbus 3, which is in this context embodied as an Industrial Ethernet fieldbus. The transmission medium may be a 4-wire twisted pair cable or a fiber optic cable, for example. The illustration of only one server subscriber or only one client subscriber in FIG. 1 is not to be understood as restrictive. A number of server subscribers or client subscribers may always be connected to each other via the Industrial Ethernet network.

The use of the EtherCAT protocol in the automation system for interpreting the data in the user data block of the Ethernet telegrams is indicated in the type field in the header of the Ethernet telegram. In principle, any known real-time-capable or non-real-time-capable fieldbus system may be used to process the data in the user data block of the Ethernet telegram.

In the automation system shown in FIG. 1, a network coupler 21 is provided in the client device 2 using the EtherCAT protocol, which comprises an external interface 211 for connection to the serial fieldbus 3. The external interface 211 of the network coupler 1 is equipped with a receiving unit RX for receiving an Ethernet telegram from the transmission medium of the serial field bus 3 and a transmitting unit TX for transmitting an Ethernet telegram on the transmission medium of the serial field bus 3.

The network coupler 21 is further connected via an internal interface 212 to a series of EtherCAT devices 22, which are identified as EtherCAT units 22-1 to 22-n, via a ring-shaped transmission path 23. The ring-shaped transmission path 23 connects the EtherCAT units 22-1 to 22-n to form a ring topology. One or more EtherCAT units 22-1 to 22-n may be a mediator in order to connect Ethernet APL field devices.

The ring-shaped transmission path 23 may comprise a simple and also cheap 4-wire transmission physics based on Low Voltage Differential Signaling (LVDS) with a short range. In order to convert the Ethernet telegram from the transmission physics of the serial field bus 3 to the transmission physics of the ring-shaped transmission path 23, a coupler interface 213 is provided in the network coupler 21, which is arranged between the external interface 211 and internal interface 212 of the network coupler 21.

Data transmission in the ring topology takes place from the network coupler 21 to the first EtherCAT unit 22-1 and from there to the last EtherCAT unit 22-n and then back to the network coupler 21.

An Ethernet telegram received by the network coupler 21 consists of the header with the receiver ID and the destination and source address, the user data area and the trailer. The user data area provided between the header and the trailer contains the process data required for the control task, which preferably represents an entire process image. The process data is in turn grouped into data blocks required for the individual subscribers in the control task, i.e. for the first EtherCAT unit 22-1 “Data EtherCAT unit 22-1”, etc.

The Ethernet telegram with the user data for the individual EtherCAT units 22-1 to 22-n sent by the server device 1 via the serial field bus 3 is received by the receiving unit RX of the external interface 211 of the network coupler 21. The received Ethernet telegram is then forwarded from the external interface 211 to the internal interface 212 in the network coupler 21 after conversion from the transmission physics of the serial field bus 3 to the transmission physics of the ring-shaped transmission path 23 by the coupler interface 213, wherein the internal interface 212 then outputs the Ethernet telegram to the ring-shaped transmission path 23 without any significant delay.

Each EtherCAT unit 22-1 to 22-n connected to the ring-shaped transmission path 23 then takes data from the data block intended for the EtherCAT unit in the circulating Ethernet telegram or inserts data into the data block. The Ethernet telegram is then transmitted back to the internal interface 212 of the network coupler 21 after passing through the last EtherCAT unit 22-n.

The coupler interface 213 of the network coupler 1 converts the Ethernet telegram from the transmission physics of the ring-shaped transmission path 23 to the transmission physics of the serial field bus 3 and then forwards the Ethernet telegram to the external interface 211, which sends the Ethernet telegram to the server subscriber 1 with the TX transmission unit on the serial field bus 3.

The EtherCAT units connected to the network coupler are regarded by the Ethernet network as a single standard Ethernet device. Due to the coupler connection in the network coupler, the Ethernet telegram received by the network coupler is output to the ring structure without significant delay, so that each EtherCAT unit may read data from the data block in the Ethernet telegram directed to the respective EtherCAT unit during the passage of the Ethernet telegram on the ring-shaped transmission path or insert data into the data block. The advantages of this procedure are that no significant delays occur during data processing due to the processing of the Ethernet telegram in the run-through and therefore short response times, as required for a real-time application, may be maintained.

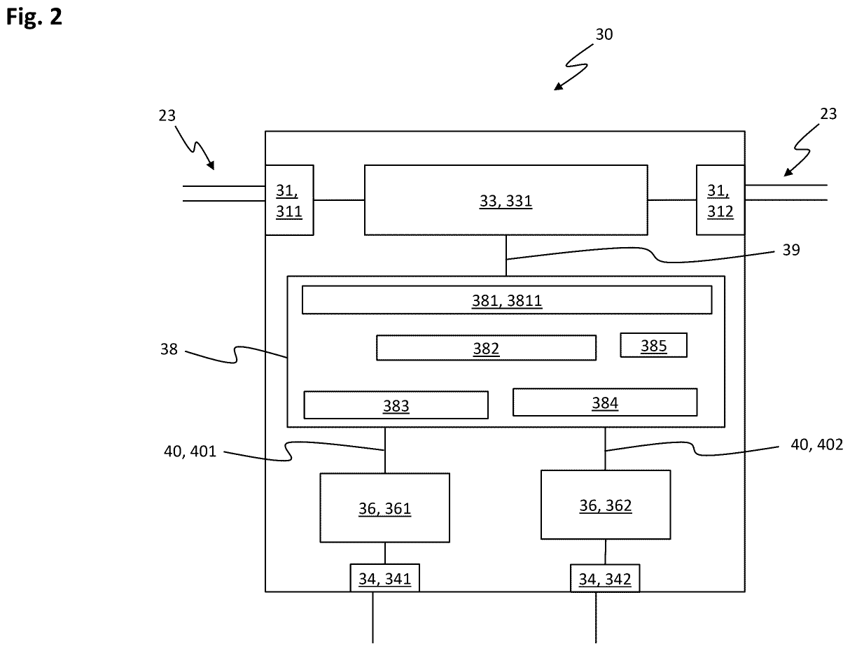

FIG. 2 shows a possible embodiment of one of the EtherCAT units 22-1 to 22-n in the automation system shown in FIG. 1 as a mediator 30 for connecting Ethernet APL field devices.

The mediator 30 comprises two first connecting interfaces 31, which are in this context embodied as a first EtherCAT port 311 and as a second EtherCAT port 312 and which are connected to the ring-shaped transmission path 23. Between the two EtherCAT ports 311, 312, a first switch-on unit 33 is connected in the mediator, which is in this context embodied as an EtherCAT switch-on unit 331 and which processes the circulating Ethernet telegrams as they pass through. The EtherCAT switch-on unit 331 extracts data from the data block in the Ethernet telegram assigned to the mediator 30 while the Ethernet telegram is passing through the mediator or inserts data into the data block in the Ethernet telegram while the Ethernet telegram is passing through the mediator.

For the field level, the mediator 30 comprises an Ethernet APL switch-on unit for each Ethernet APL port, which processes Ethernet APL telegrams from the assigned Ethernet APL port.

FIG. 2 shows two second connecting interfaces 34, which are in this context as a first Ethernet APL port 341 and as a second Ethernet APL port 342. The two Ethernet APL ports 341, 342 are each assigned a second switch-on unit 36, which are in this context as a first Ethernet APL switch-on unit 361 and as a second Ethernet APL switch-on unit 362. In principle, any number of Ethernet APL ports and associated Ethernet APL switch-on units may be provided. Ethernet APL field devices are then connected to the individual Ethernet APL ports via a 2-wire cable.

Ethernet APL switch-on units process Ethernet telegrams with data from the Ethernet APL field devices or for the Ethernet APL field devices that are received or transmitted via the assigned Ethernet APL port. The Ethernet telegrams are processed using a superordinate Ethernet protocol that is implemented in the Ethernet APL switch-on unit and is PROFINET in the embodiment described.

The mediator 30 also includes a mediator controller 38, which is connected to the EtherCAT switch-on unit via a first SPI (Serial Peripheral Interface) interface 39 and to the two Ethernet APL switch-on units 361, 362 via two further SPI interfaces 40, a second SPI interface 401 and a third SPI interface 402.

As a software module, the mediator controller 38 contains an Industrial Ethernet protocol module 381, a translator module 382, hereinafter also referred to as gateway module, and two Ethernet APL protocol modules, a first Ethernet APL protocol module 383 and a second Ethernet APL protocol module 384, which are each allocated to an Ethernet APL switch-on unit.

In the Industrial Ethernet protocol module 381, which is in this context embodied as an EtherCAT protocol module 3811, the EtherCAT data blocks made available via the first SPI interface 39 are interpreted and divided up into individual services. The two Ethernet APL protocol modules 383, 384 each interpret the Ethernet APL data provided via the second and third SPI interfaces 401, 402 and allocate them to individual services. The gateway module 382 arranged between the EtherCAT protocol module 3811 and the two Ethernet APL protocol modules 383, 384 connects the individual services and coordinates the services in terms of time so that the services do not interfere with one another.

The mediator controller 38 is always configured in such a way that it does not forward any data between Ethernet APL ports. From the point of view of the mediator, physically completely separate Ethernet APL ports are provided at any time.

Since all communication and all services run via the gateway module, firewall functions may also be implemented therein. Such a firewall unit 385 may additionally be integrated into the mediator controller 38 and, as shown in FIG. 2, be available as an additional software module.

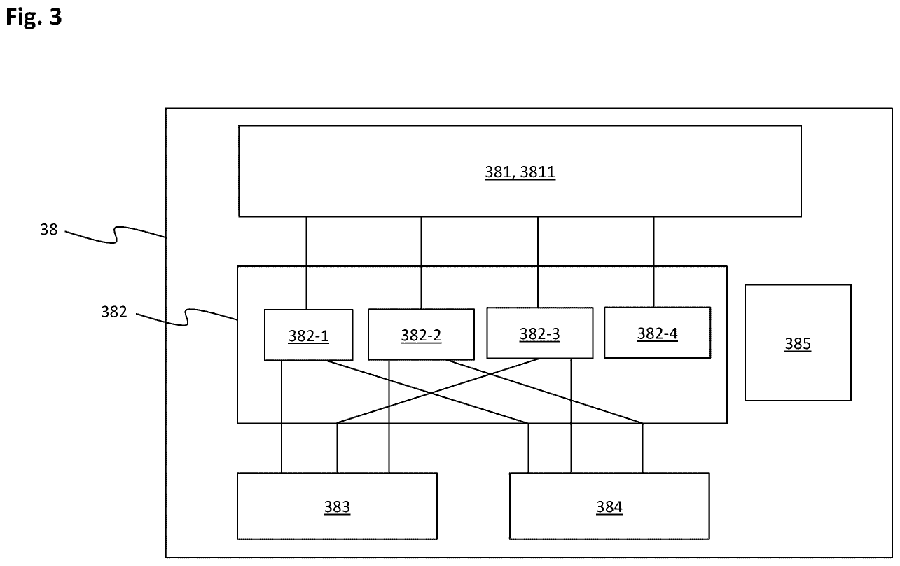

FIG. 3 shows the structure of the mediator controller 38 in more detail, with the data flows between the software modules in the mediator controller 38 being indicated.

The EtherCAT protocol module 3811 of the mediator controller 38 is equipped with an EtherCAT protocol stack. The EtherCAT protocol stack accepts the EtherCAT data blocks received from the EtherCAT switch-on unit via the first SPI interface, unpacks the EtherCAT data blocks and forwards the EtherCAT data blocks containing data sorted according to various configured services to the gateway module.

The first and second Ethernet APL protocol modules 383, 384 of the mediator controller 38 are each provided with an Ethernet APL protocol stack which uses the Ethernet protocol superordinate to the Ethernet APL, in the PROFINET embodiment described. The Ethernet APL protocol stack processes the user data of the Ethernet telegrams received via the respectively assigned SPI interface from the corresponding Ethernet APL switch-on unit and transfers the data to the gateway module sorted according to the various services set up.

The gateway module 382 contains service filters assigned to the individual services. In the embodiment shown in FIG. 3, four service filters are provided, the control cycle service filter 382-1, the CAN over EtherCAT service filter 382-2, the ADS over EtherCAT service filter 382-3 and the Ethernet over EtherCAT service filter 382-4. The service filters shown in FIG. 3 should not be understood to be restrictive. In principle, further service filters may be provided. In particular, more or fewer service filters may also be provided.

The cyclic control data taken from the EtherCAT data blocks contains Ethernet APL port information so that the control cycle service filter 382-1 may send the corresponding data directly to the corresponding Ethernet APL protocol module assigned to the Ethernet APL port. The Ethernet APL protocol module then packs the cyclic control data into an Ethernet telegram and forwards the Ethernet telegram via the assigned SPI interface to the corresponding Ethernet APL switch-on unit, which outputs the Ethernet telegram on the Ethernet APL port connected to the Ethernet APL switch-on unit.

The CoE data taken from the EtherCAT data blocks are acyclic data that are stored in various objects, including objects for configuring the Ethernet APL protocol modules. It is defined which objects are used for the configuration of the first Ethernet APL protocol module 383 and which for the configuration of the second Ethernet APL protocol module 384, so that the CoE service filter 382-2 may filter the objects and forward them directly to the corresponding Ethernet APL protocol modules.

The AoE service is a freely definable acyclic service, wherein it is defined how acyclic Ethernet APL services are mapped to the AoE service. The mapping also contains address information that enables the AoE service filter 382-3 in the gateway module 382 to separate the Ethernet APL ports and forward the data to the corresponding Ethernet APL protocol module. The Ethernet APL protocol module then packs the acyclic data into an Ethernet telegram and forwards the Ethernet telegram to the assigned Ethernet APL switch-on unit, which outputs the Ethernet telegram on the connected Ethernet APL port.

The EoE service tunnels Ethernet telegrams through the EtherCAT acyclic services, unpacks them and forwards the Ethernet telegrams to the EoE service filter 382-4. The EoE service filter 382-4 may then filter out the Ethernet APL port based on the destination address contained in each Ethernet telegram and sends the Ethernet telegram directly to the assigned Ethernet APL switch-on unit, bypassing the Ethernet APL protocol modules.

When sorting the user data of the Ethernet telegrams received via the respectively assigned SPI interface from the corresponding Ethernet APL switch-on unit by the first and second Ethernet APL protocol modules 383, 384 of the mediator controller 38, the service filters then do not have to make a port assignment, since only a single EtherCAT switch-on unit is provided.

The firewall unit 385 is connected to the gateway module 382 and may check the data flows of all service filters on the basis of security specifications and then block a corrupted data flow if necessary.

A data flow from server subscriber 1 to an Ethernet APL actuator connected to the first Ethernet APL port 341 would be carried out as follows.

The actuator control data is generated by the server device 1 as part of a control process and packed into an EtherCAT data block of an Ethernet telegram. Server subscriber 1 then sends the Ethernet telegram to client subscriber 2 via the serial fieldbus 3.

The network coupler 21 of the client subscriber 2 then converts the Ethernet telegram from the transmission physics of the serial field bus 3 to the transmission physics of the ring-shaped transmission path 23 and then outputs the Ethernet telegram on the ring-shaped transmission path 23.

The mediator 30 processes the circulating Ethernet telegrams on the fly with the EtherCAT switch-on unit 331. The EtherCAT switch-on unit 331 extracts the EtherCAT data block from the Ethernet telegram and forwards the EtherCAT data block to the EtherCAT protocol module 3811 of the mediator controller 38 via the first SPI interface 39.

The EtherCAT protocol stack in the EtherCAT protocol module 3811 takes the actuator control data and forwards the actuator control data to the control cycle service filter 382-1 in the gateway module 382.

The actuator control data extracted from the EtherCAT data block contains Ethernet APL port information, so that the control cycle service filter 382-1 forwards the data directly to the first Ethernet APL protocol module 383, which is assigned to the first Ethernet APL port 341.

The first Ethernet APL protocol module 383 then packages the actuator control data into an Ethernet telegram and forwards the Ethernet telegram via the associated second SPI interface 401 to the first Ethernet APL switch-on unit 361, which outputs the Ethernet telegram on the first Ethernet APL port 341 connected to the first Ethernet APL switch-on unit 361 to which the Ethernet APL actuator is connected.

A high port density and compact installation space may be achieved by embodying the mediator 30 as terminal blocks. In addition, the integration of the mediator as a terminal block in a bus terminal unit allows for a modular and flexible realization of the Ethernet APL.

A bus terminal unit consists of a bus coupler and a large number of electronic terminal blocks. The bus Coupler has an interface to the fieldbus and thus connects the bus terminals to the central controller. Bus couplers may be equipped with their own intelligence and have PLC functionality on a small scale in order to process smaller control tasks decentrally without the intervention of the central controller.

The bus coupler corresponds to the Ethernet coupler 21 shown in FIG. 1 and is the link between the Ethernet protocol at fieldbus level and the terminal blocks. Communication between the bus coupler and the individual terminal blocks then takes place via an internal Ethernet terminal bus, which connects the terminal blocks wirelessly via contacts.

The bus coupler converts the transmission physics of the fieldbus level and the terminal block level into each other without changing the process data stream. For example, the bus coupler converts Ethernet telegrams from Ethernet 100BASE-TX physics on the fieldbus to the internal Ethernet terminal bus. The internal Ethernet terminal bus is also transmitted at 100 Mbit/s, however, it has a more cost-effective physical layer based on Low Voltage Differential Signaling (LVDS).

The bus terminal unit is usually installed in a control cabinet on a top-hat rail. Bus terminals having a wide variety of signal types may be arranged in any order in the bus terminal unit. It is also possible to replace individual bus terminals or subsequently extend the bus terminal unit within the physical limits of the system.

Bus terminal units may be used wherever analog and digital inputs and outputs (I/Os) are to be wired and transmitted to a central controller via a fieldbus. Bus terminal units make it possible to bundle the large number of different signals from sensors and forward them to the central controller via a standardized bus signal or to forward commands from the central controller to the actuators.

By using mediators in the form of terminal blocks within a bus terminal string, it is possible to transfer signals from subordinate levels that communicate via an Ethernet APL to the superordinate fast industrial Ethernet fieldbus.

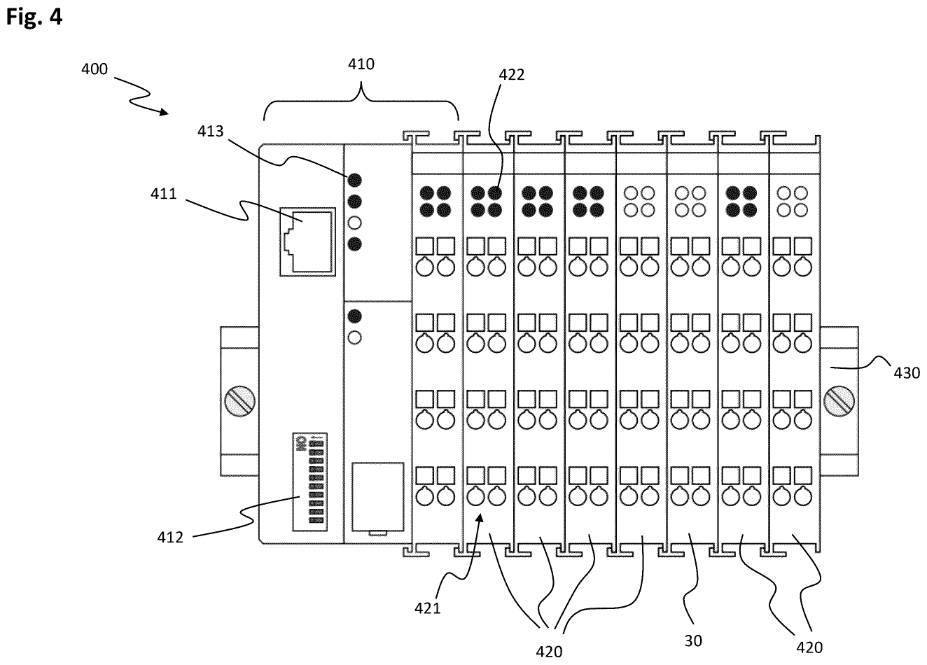

FIG. 4 shows a bus terminal unit 400 in which the mediator 30 is integrated as a terminal block. The bus terminal unit 400 has, as its first module, a bus coupler 410, which may comprise a slot 411 for a bus cable. The slot 411 may, for example, be embodied as an RJ45 socket in order to accommodate an RJ45 plug of the bus cable. Furthermore, the bus coupler comprises a plurality of DIP (Dual in-line Package) switches 412, for example in order to set an address. Furthermore, a plurality of LEDs 413 is arranged on the bus coupler to indicate an operating status of the bus coupler.

The bus coupler 410 in FIG. 4 is connected to 7 terminal blocks 420, with the fifth terminal block being the mediator 30. The number of terminal blocks shown in FIG. 4 is not intended to be restrictive. In particular, more or fewer of the terminal blocks may be provided. For example, up to 255 terminal blocks may be provided in one configuration of the bus terminal unit.

The terminal blocks 420, including the mediator 30 in FIG. 4, have an identical design and have two opposite outer sides, on each of which contact arrangements are provided via which communication and voltage supply take place. The design of the terminal blocks, particularly with regard to the width of the terminals, may vary.

Connection devices for cables for the direct connection of sensors and actuators or subordinate fieldbus systems are formed on the front of the terminal blocks. In the terminal blocks 420 shown in FIG. 4, four 2-wire connection devices 421 are shown per terminal block, arranged one above the other. However, the terminal blocks may also be equipped with different connecting options.

Furthermore, a plurality of LEDs 422 is arranged on the terminal block front side to indicate the operating status of the terminal block. The individual terminal blocks 420 are plugged to one another and latched onto a top-hat rail 430. The top-hat rail 430 may, for example, be mounted in a control cabinet with the aid of screws.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

| | |
|---|---|
| 1 Server subscriber | 381 Industrial Ethernet protocol |
| | module |
| 2 Client subscribers | 3811 EtherCAT protocol module |
| 3 Serial field bus | 382 Translator module |
| 21 Network coupling device | 382-1 Control cycle service filter |
| 22 EtherCAT subscriber | 382-2 CoE service filter |
| 22-1 to 22-n EtherCAT unit | 382-3 AoE service filter |
| 23 Ring-shaped transmission path | 382-4 EoE service filter |
| 30 Mediator | 383 First Ethernet APL protocol |
| | module |
| 31 First connecting interface | 384 Second Ethernet APL protocol |
| | module |
| 34 Second connecting interface | 385 Firewall unit |
| 36 Second switch-on unit | 401 Second SPI interface |
| 38 Mediator controller | 402 Third SPI interface |
| 39 First SPI interface | 400 Bus terminal unit |
| 40 Further SPI interface | 410 Bus coupler |
| 211 External interface | 411 Slot |
| 212 Internal interface | 412 DIP switch |
| 213 Coupler connection | 413 Bus coupler LED |
| 311 First EhterCAT port | 420 Terminal blocks |
| 312 Second EtherCAT port | 421 2-wire connecting device |
| 331 EtherCAT switch-on unit | 422 Terminal block LED |
| 341 First Ethernet APL port | 430 Top hat rail |
| 342 Second Ethernet APL port | |
| 361 First Ethernet APL switch- | |
| on unit | |
| 362 Second Ethernet APL switch- | |
| on unit | |

What is claimed is:

1. A mediator comprising:
a mediator controller, the mediator controller comprising an Industrial Ethernet protocol module, at least one Ethernet APL protocol module and a translator module connected to the Industrial Ethernet protocol module and the at least one Ethernet APL protocol module;
wherein the Industrial Ethernet protocol module is configured to interpret Industrial Ethernet data provided via a first SPI interface and to allocate Industrial Ethernet services,
wherein the at least one Ethernet APL protocol module is configured to interpret Ethernet APL data made available via a further SPI interface and to allocate Ethernet APL services, and
wherein the translator module is configured to connect the Industrial Ethernet services and the Ethernet APL services to one another and to coordinate them in time.

2. The mediator according to claim 1, wherein the translator module comprises service filters allocated to the services.

3. The mediator according to claim 1, wherein the mediator controller comprises a firewall to filter and/or to prevent unwanted communication.

4. The mediator according to claim 1, wherein a super-ordinate Ethernet protocol is used in the Ethernet APL protocol module.

5. The mediator according to claim 1, wherein an EtherCAT protocol is used in the Industrial Ethernet protocol module.

6. The mediator according to claim 1, wherein the mediator is configured as a terminal block.

7. A mediator comprising:
a first connecting interface configured for a first Ethernet media type, which is configured an industrial Ethernet having a transmission rate of more than 10 Mbit/s,
a first switch-on unit connected to the first connecting interface configured for the first Ethernet media type,
at least one second connecting interface configured for a second Ethernet media type, which is configured as an Ethernet APL 10 Base-T1L having a transmission rate of 10 Mbit/s on a single-pair Ethernet cable,
at least one second switch-on unit configured for the second Ethernet media type connected to the at least one second connecting interface,
a mediator controller which comprises an industrial Ethernet protocol module, at least one Ethernet APL protocol module and a translator module connected to the industrial Ethernet protocol module and the at least one Ethernet APL protocol module,
a first SPI (Serial Peripheral Interface) interface, which connects the first switch-on unit to the industrial Ethernet protocol module of the mediator controller, and
a further SPI interface, which connects the second switch-on unit to the at least one Ethernet APL protocol module of the mediator controller;
wherein the first switch-on unit is configured to process Industrial Ethernet data from Industrial Ethernet telegrams transmitted by the first connecting interface and to exchange them with the Industrial Ethernet protocol module of the mediator controller via the first SPI interface,
wherein the Industrial Ethernet protocol module is configured to interpret the Industrial Ethernet data made available via the first SPI interface and to allocate Industrial Ethernet services,
wherein the at least one second switch-on unit is configured to process Ethernet APL data from Ethernet APL telegrams transmitted by the at least one second connecting interface and to exchange them via the further SPI interface with the at least one Ethernet APL protocol module of the mediator controller,
wherein the at least one Ethernet APL protocol module is configured to interpret Ethernet APL data made available via the further SPI interface and to assign Ethernet APL services, and
wherein the translator module is configured to connect the Industrial Ethernet services and the Ethernet APL services to each other and to coordinate them in time.

8. The mediator according to claim 7, wherein the translator module comprises service filters allocated to the services.

9. The mediator according to claim 7, wherein the mediator controller comprises a firewall to filter and/or to prevent unwanted communication.

10. The mediator according to claim 7, wherein a super-ordinate Ethernet protocol is used in the Ethernet APL protocol module of the mediator.

11. The mediator according to claim 7, wherein the first switch-on unit is an EtherCAT switch-on unit, and wherein an EtherCAT protocol is used in the Industrial Ethernet protocol module.

12. The mediator according to claim 7, wherein the mediator is configured as a terminal block.

13. The mediator according to claim 7, wherein the mediator is configured as a multi-port terminal block.

14. An automation system comprising:
a server subscriber, and
a mediator configured as client subscriber;
wherein the mediator comprises a mediator controller, the mediator controller comprising an Industrial Ethernet protocol module, at least one Ethernet APL protocol module and a translator module connected to the Industrial Ethernet protocol module and the at least one Ethernet APL protocol module,
wherein the Industrial Ethernet protocol module is configured to interpret Industrial Ethernet data provided via a first SPI interface and to allocate Industrial Ethernet services,
wherein the at least one Ethernet APL protocol module is configured to interpret Ethernet APL data made available via a further SPI interface and to allocate Ethernet APL services, and
wherein the translator module is configured to connect the Industrial Ethernet services and the Ethernet APL services to one another and to coordinate them in time.

15. The automation system according to claim 14, wherein a bus terminal unit is provided which comprises a bus coupler and a number of terminal blocks, wherein the mediator comprises a terminal block.

16. The automation system according to claim 14, wherein the translator module comprises service filters allocated to the services.

17. The automation system according to claim 14, wherein the mediator controller comprises a firewall to filter and/or to prevent unwanted communication.

18. The automation system according to claim 14, wherein a super-ordinate Ethernet protocol is used in the Ethernet APL protocol module.

19. The automation system according to claim 14, wherein an EtherCAT protocol is used in the Industrial Ethernet protocol module.

20. The automation system according to claim 14, wherein the mediator is configured as a terminal block.
